(19) United States
(12) Patent Application Publication
(10) Pub. No.: US 2009/0187439 A1
(43) Pub. Date: Jul. 23, 2009

(54) COMMISSION TRACKING WEB SERVICES

(75) Inventors: Cordell W. Christopher, JR., Lacey, WA (US); Levi J. Crain, Lacey, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: COMMISSION TRAX, LLC, Lacey, WA (US)

(21) Appl. No.: 12/016,916

(22) Filed: Jan. 18, 2008

Related U.S. Application Data
(60) Provisional application No. 61/022,100, filed on Jan. 18, 2008.

(51) Int. Cl. G06Q 10/00

(52) U.S. Cl. 705/7

(57) ABSTRACT

Web services allow a real estate professional to create tracking services to monitor commission transactions, expense transactions, performance goals, taxes, and so on. Using an Internet client, the real estate professional creates a tracking service by accessing a server across a network. The tracking service allows the real estate professional to add, edit, and delete commission transactions associated with clients and various pieces of property. Expenses can also be tracked to allow the real estate professional to better understand revenue and costs connected with the revenue.

### CROSS-REFERENCE TO A RELATED APPLICATION

This application claims the benefit of U.S. Provisional Application No. 61/022,100, filed Jan. 18, 2008, which is incorporated herein by reference.

### BACKGROUND

A real estate agent who is an expert in property, including buildings and land, often is not an expert at running a real estate business. There are tools available to help the real estate agent to better market his real estate services, such as producing a brochure about a property. But none of these tools helps him to manage commission transactions and other financial transactions connected with the commission transactions.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with various aspects of this invention, a method form of the invention includes a method for tracking real estate transactions over a network. The method comprises presenting a first Web page that creates a tracking service for a real estate agent and receiving over the network a selection for one of many tracking subscription service levels, a split percentage for the real estate agent, a split percentage for a broker, and a tax rate. The method further comprises presenting a second Web page that creates a transaction to be tracked by the tracking service and receiving over the network a client name connected with the transaction, a multiple listing service number, a sales price for a piece of property, a property type, a commission rate, a source of the commission, a split percentage, and a closing date.

In accordance with another aspect of this invention, a system form of the invention includes a computer system for tracking real estate transactions over a network. The computer system comprises a server that executes software for sending a first Web page to an Internet client to create a tracking service for a real estate agent, the server receiving over the network a selection for one of many tracking subscription service levels, a split percentage for the real estate agent, a split percentage for a broker, and a tax rate. The server sends a second Web page to create a transaction to be tracked by the tracking service and receives over the network a client name connected with the transaction, a multiple listing service number, a sales price for a piece of property, a property type, a commission rate, a source of the commission, a split percentage, and a closing date. The computer system further comprises a database server for storing the selection for one of many tracking subscription service levels, the split percentage for the real estate agent, the split percentage for a broker, and the tax rate, the transaction to be tracked by the tracking service, including the client name connected with the transaction, the multiple listing service number, the sales price for the piece of property, the property type, the commission rate, the source of the commission, the split percentage, and the closing date.

In accordance with yet another aspect of this invention, a computer-readable medium form of the invention includes a computer-readable medium having computer-executable instructions stored thereon for implementing a method for tracking real estate transactions over a network. The method comprises presenting a first Web page that creates a tracking service for a real estate agent and receiving over the network a selection for one of many tracking subscription service levels, a split percentage for the real estate agent, a split percentage for a broker, and a tax rate. The method further comprises presenting a second Web page that creates a transaction to be tracked by the tracking service and receiving over the network a client name connected with the transaction, a multiple listing service number, a sales price for a piece of property, a property type, a commission rate, a source of the commission, a split percentage, and a closing date.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary system in accordance with one embodiment of the present invention;

FIG. 2 is a pictorial diagram illustrating an exemplary Web page in accordance with one embodiment of the present invention;

FIG. 3 is a pictorial diagram illustrating an exemplary Web page in accordance with one embodiment of the present invention;

FIG. 4 is a pictorial diagram illustrating an exemplary Web page in accordance with one embodiment of the present invention;

FIG. 5 is a pictorial diagram illustrating an exemplary Web page in accordance with one embodiment of the present invention;

FIG. 6 is a pictorial diagram illustrating exemplary entities of a database in accordance with one embodiment of the present invention; and

FIGS. 7A-7J are process diagrams illustrating an exemplary method for tracking real estate agents' commissions, expenses, taxes, and goals in accordance with one embodiment of the present invention.

### DETAILED DESCRIPTION

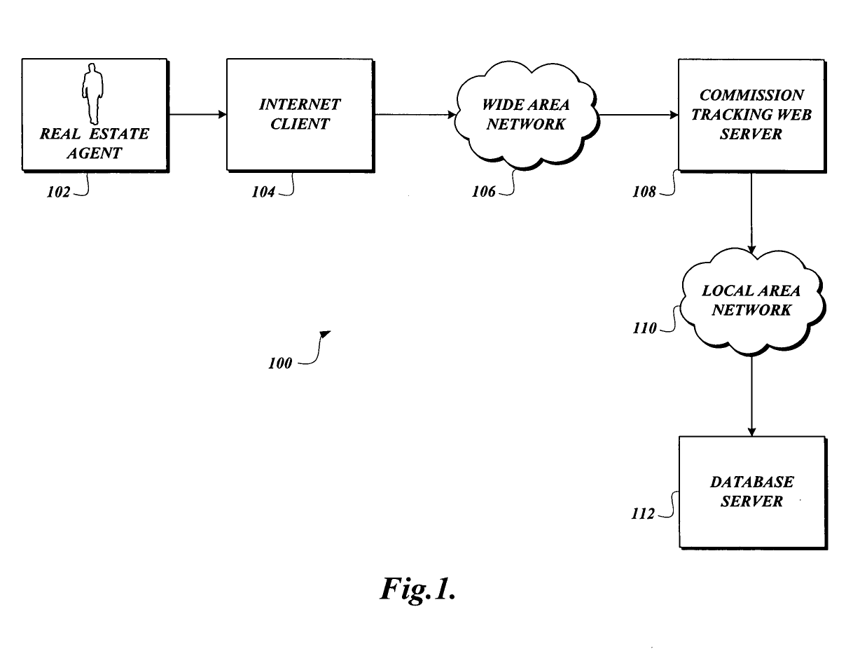

FIG. 1 illustrates a system 100 that facilitates Web services for a real estate agent 102 to track his real estate commissions and other business transactions to help motivate achievements of certain business goals. To access the system 100, the real estate agent 102 interacts with an Internet client 104. One suitable Internet client 104 that may be used by the real estate agent 102 includes a Web browser that allows the real estate agent to view tag-based documents and access files and software related to those documents provided by the system 100. The Internet client 104 is preferably built using hyperlinks, which allow the real estate agent 102 to interact with a Web-based user interface by pointing and clicking with a mouse in order to jump from one Web page to another Web page in whatever order the real estate agent 102 desires. The Internet client 104 is also capable of downloading and transferring files, providing access to business information, displaying graphics (such as business charts embedded in Web documents), playing audio and video files associated with the Web documents, and executing small programs, such as Java applets or ActiveX controls.

The Internet client 104 accesses the remaining components of the system 100 via a wide area network 106. The wide area network 106 is a geographically widespread network relying on communications capabilities to link various network segments. One suitable implementation of the wide area network 106 includes the Internet or a wireless network, such as the cellular network. Coupled to the wide area network 106 and responding to requests by the Internet client 104 is the commission tracking Web server 108. The commission tracking Web server 108 provides various Web services requested by the real estate agent 102 via the Internet client 104. Preferably, the commission tracking Web server 108 is coupled to a database server 112 via a local area network 110. Suitably, the commission tracking Web server 108 is implemented using active server pages (or PHP which is a server-side technology environment for ported script engines) and JavaScript that need not use domain name system-type connections to connect to the database server 112. Instead, the commission tracking Web server 108 is suitably coupled to the database server 112 via an application programming interface called Active Data Object to access information contained in the database server 112.

As an alternative connection to the database server 112, the commission tracking Web server 108 also may use an SQL object linking and embedding database application programming interface for accessing the database server 112. Suitably, the database server 112 is implemented using an SQL database server. Additionally, to manage access to data contained by the database server 112, the commission tracking Web server 108 uses a cursor type of the adOpenKeyset protocol when writing data. For other database transactions, the commission tracking Web server 108 suitably uses the adOpenStatic protocol. For connecting to the database server 112, the commission tracking Web server 108 uses a lock type called adLockOptimistic.

When the commission tracking Web server 108 requests data, the data is transferred from the database server 112 to the commission tracking Web server 108 via the local area network 110. When the commission tracking Web server 108 is satisfied that it has all the data it needs to complete a request from the Internet client 104, the commission tracking Web server 108 outputs the data in a tag-based format to be sent across the wide area network 106 to be received by the Internet client 104 for presentation on the display to the real estate agent 102.

The software of the commission tracking Web server 108 is suitably divided logically into three layers: a presentation layer, business logic level, and data access layer. The presentation layer uses active server pages to format data into a form that the real estate agent 102 may view on the Internet client 104. The active server pages of the presentation layer may make a programming call to the business logic level to obtain information, such as the sales price of a piece of property, the sales date, etc. Inside a function call, it may yet call other functions that interact with the data access layer. The data access layer attempts to open the database server 112, perform a query, and return the queried data back to the business logic level. Correspondingly, when the business logic level needs to write or save data into the database server 112, the data access layer is again executed to open the database server 112 and save the information inside one or more entities of the database server 112.

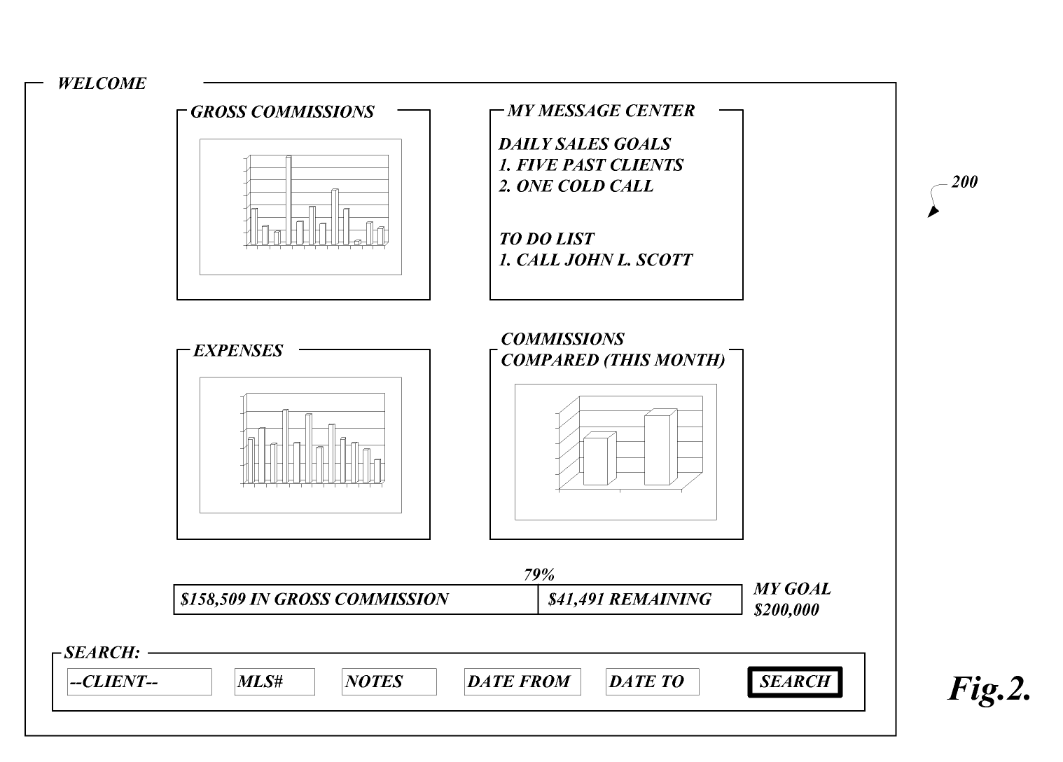

FIG. 2 illustrates a dashboard Web page 200 that welcomes the real estate agent 102 when he has gained access to the system 100 via the Internet client 104. Such access may be gained by entering a previously registered e-mail address and a corresponding password. Six major areas are presented on the Web page 200. One area entitled “Gross Commissions” located in the upper left of the Web page 200 displays the gross commissions over various months, which were accumulated by the real estate agent 102. Preferably, a graph is shown so as to allow the real estate agent 102 to quickly visualize his performance. The graph may be two-dimensional or multi-dimensional. The Y-axis includes the gross commissions in dollars, and the X-axis includes months in which the gross commissions were tabulated. When the real estate agent 102 drags a pointer controlled by a mouse across the graph, the system 100 may respond by displaying a gross commission amount connected with a particular month at the location at which the pointer of the mouse hovers.

In the upper right hand corner of the Web page 200 is a “My Message Center” area. In this area, the real estate agent 102 may provide daily sales goals or inspiring messages; below it is a to-do list with which the real estate agent 102 may track tasks to be done. Below the “My Message Center” area is an area titled “Commissions Compared (This Month)” in which another chart is provided, allowing the real estate agent 102 to compare his gross commissions in one particular month in comparison with the same month one year ago. Again, when the real estate agent 102 drags a pointer connected with a mouse over the chart, a numerical amount appears representing the gross commission for the particular month.

To the left of the area just discussed is an area titled “Expenses.” A chart is provided that displays all the months in which expenses of the real estate agent 102 were tabulated. Preferably, the Y-axis is in dollars and the X-axis is in months. By dragging the pointer connected with the mouse over the chart in the “Expenses” area, an amount of expenses connected with a particular month may appear. Below the “Expenses” area of the Web page 200 is a chart with a single bar running widthwise along the Web page 200. The chart is divided into two portions, the first portion displaying the accumulated gross commissions, such as “$158,509 in gross commissions,” and a second portion displaying a remaining amount to achieve to reach a set goal, such as “$41,491 remaining.” These two portions are separated by a vertical bar, at the top of which is a percentage number indicating a part of the accumulated gross commissions expressed as a percentage, such as “79%.” To the right, at the end of the bar, is the stated goal of the real estate agent 102, such as “My Goal $200,000.”

Below, at the bottom of the Web page 200 is a search dialog box that allows the real estate agent 102 to perform searches for information contained in the database server 112. A portion of the search dialog box allows the real estate agent 102 to search by clients, which the real estate agent 102 has previously identified to the system 100. Upon clicking the client portion of the search dialog box, a drop-down menu appears, listing the clients of the real estate agent 102. By selecting a client and clicking the search button that appears to the left of the search dialog box, a search query will be issued to the database server 112, and the results will be returned to the Internet client 104.

Instead of searching by clients, the real estate agent 102 may search by the MLS (Multiple Listing Service) numbers. By selecting the “MLS#” area of the search dialog box, the real estate agent 102 may enter an MLS number via a keyboard. Again, selecting the search button will cause a search query to be issued to the database server 112. Alternatively, if the real estate agent 102 has entered notes into a particular commission transaction, such notes can be searched via the search dialog box by selecting the “notes” area of the dialog box and inputting the string expression that may cause the system 100 to retrieve transactions connected with such notes. Finally, the real estate agent 102 may search for transactions by using date ranges. The date ranges may be delimited by selecting an appropriate date from the “date from” area and “date to” areas of the search dialog box.

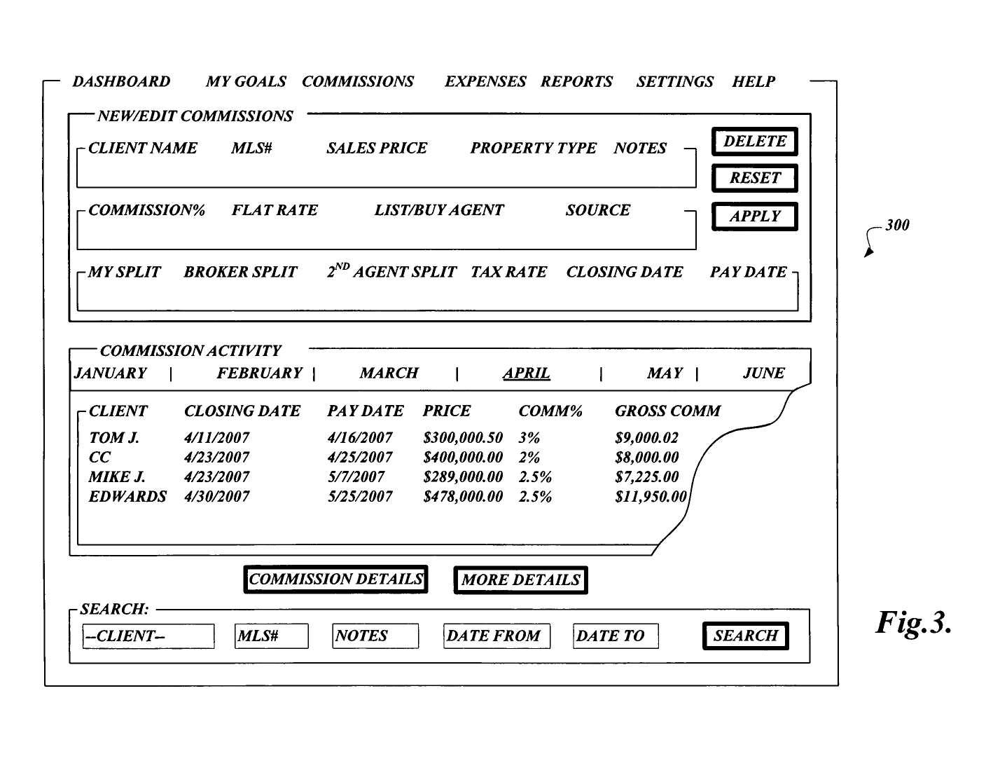

FIG. 3 illustrates a Web page 300 which is presented to the real estate agent 102 when a hyperlink “commissions” is selected by the real estate agent 102. The hyperlink “commissions” can be found at the top of the Web page 300, which also includes a number of other hyperlinks acting as menus at the top of the Web page. The hyperlinks include “dashboard,” which, when selected, will present the Web page 200; a hyperlink “my goals,” which will be discussed below; a hyperlink “commissions,” which, when selected, will cause the Web page 300 to appear; a hyperlink “expenses,” which will be discussed below; and hyperlinks “reports,” “settings,” and “help.” The Web page 300 is in three major sections, including the “new/edit commissions” section, the “commission activity” section, and the search dialog box.

The section “new/edit commissions” of the Web page 300 allows the real estate agent 102 to enter a new commission transaction or edit a current commission transaction. Three buttons to the left of the section include a “delete” button, “reset” button, and “apply” button. The “delete” button allows the real estate agent 102 to delete a particular commission transaction from the database server 112. The “reset” button allows the real estate agent 102 to undo modifications to a current commission transaction and restore the previously saved commission transaction data. The “apply” button confirms data entry for the new commission transaction or edits made to the current commission transaction, causing such new transactions or modifications to a commission transaction to be saved to the database server 112.

Three rows of dialog boxes exist inside the “new/edit commissions” section. The first row allows the real estate agent 102 to enter a client name, an MLS number connected with a piece of property, a sales price of the piece of property, property type, and notes. Regarding the property type, upon selection, a drop-down menu presents a list of property types that the real estate agent 102 can select, including commercial, condo, land, multi-family, other, resident new construction, resident resale, and customized property types created by the real estate agent 102.

The second row of the “new/edit commissions” section allows the real estate agent 102 to enter either a commission percentage or a flat rate fee connected with real estate services connected with a piece of property. If one is used, the other will be disabled. Without entering either the commission percentage or a flat rate, the system 100 will enter a default commission percentage earlier indicated by the real estate agent 102 when the real estate agent 102 set up the account with the system. The second row also allows the real estate agent 102 to indicate whether he is a listing agent or a buying agent by selecting from a list of items in a drop down menu upon selection of the “list last/buy agent” portion of the second row. The second row also allows the real estate agent 102 to indicate commission source by selecting the source portion of the second row. Various sources appear in a drop-down menu when the real estate agent 102 selects the source portion of the second row. Several sources of the commission transaction are possible, and include builder, cold call, digital signage, direct mail, floor, magazine, newspaper, open house, other, past customer, referral, relocation, sign, site, sphere, and Web site. The real estate agent 102 also has an option of customizing his own particular source of commission transactions via the Web page 300.

The third row of the “new/edit commissions” section includes a “my split” portion, which indicates the percentage of the commissions that would be earned by the real estate agent 102 before taxes and other charges. The “broker's split” portion is portion of the commissions that are automatically earned by the broker. Typically, the sum of the commissions earned by the real estate agent 102 and the commissions earned by the broker should add up to the total commissions for a piece of property. The percentages in the “my split” portion and the “broker's split” portion are set by default, but can be changed using the system 100 via the “settings” hyperlink at the top of the Web page 300.

If another real estate agent assists in the transaction, the real estate agent 102 may enter a portion of the commissions that are earned by the other agent under the “second agent split” portion of the third row. Typically, the amount of commission earned by the second agent is taken from the commissions of the real estate agent 102, as calculated using the percentage under the “my split” portion and not from the “broker's split” portion. A “tax rate” portion of the third row displays the tax rate used to determine net commissions of the real estate agent 102. The tax rate can be set by using the hyperlink “settings” of the Web page 300.

The “closing date” portion of the third row is a date that the commission is likely to be closed, due to the closing of the real estate transaction. The closing date is used to determine a month in which the commission transaction is displayed. If a closing date is entered, but not a pay date under the “pay date” portion in the third row, the transaction appears in a color or other indication to communicate to the real estate agent 102 that the particular transaction is not a pay transaction. Normally, the “pay date” portion is left blank until the transaction is closed and a pay date is known. Without a pay date, a particular transaction is reported under the commission report, but not the tax income report. These reports can be obtained by selecting the hyperlink “reports” of the Web page 300.

Below the “new/edit commissions” section is the “commission activity” section, which lists a number of month hyperlinks. The current month is automatically selected, and commission transactions connected with that month appear below in various columns. Preferably, all month options are displayed so as to allow the real estate agent 102 to select any one of the months to bring forth the commission transactions connected with the selected month. Preferably, the selected month is highlighted, such as “April” so as to allow the real estate agent 102 to understand the activities of the month in which the commission transactions appear. Not shown in FIG. 3 is the ability of the real estate agent 102 to select a particular year in which to view commission transactions. A number of columns delimit data connected with various commission transactions, including a client column, a closing date column, a pay date column, a price column, a commission percentage column, a gross commission column, a my split column, a broker's split column, a second agent split column, an after split column, a tax column, and a net commission column. Not all columns and months appear in the illustration of the Web page 300 due to space limitations. If a commission transaction has more details, the real estate agent 102 may access those details by selecting a hyperlink titled “more details.”

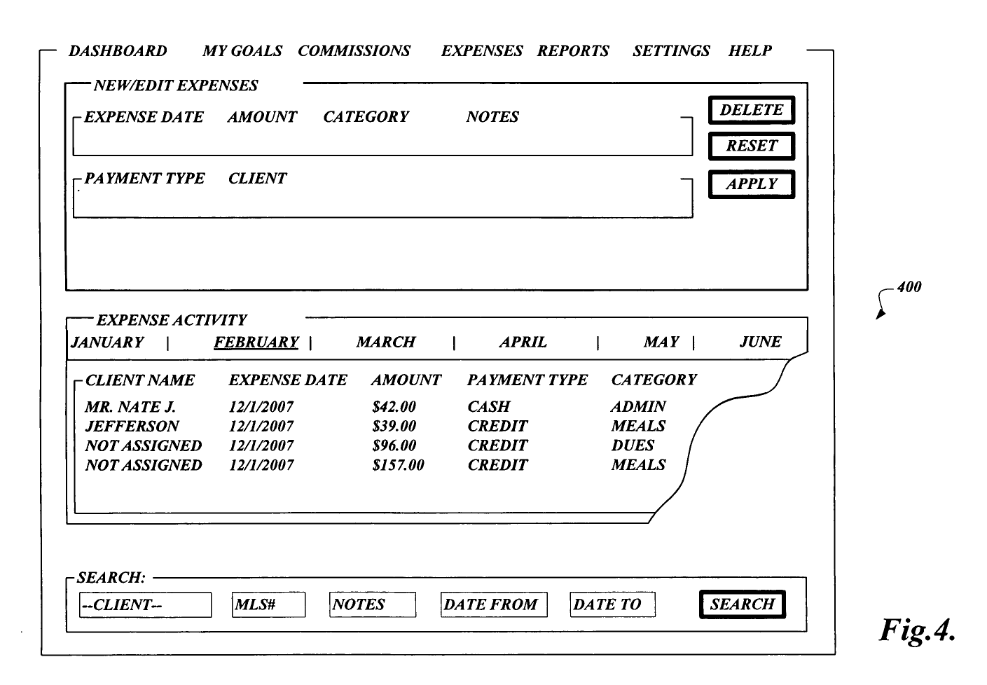

FIG. 4 illustrates a Web page 400 that includes hyperlinks similar to those previously discussed in connection with the Web page 300, such as the hyperlinks “dashboard,” “my goals,” “commissions,” “expenses,” “reports,” “settings,” and “help.” Upon selecting the hyperlink “expenses,” the Web page 400 appears on the Internet client 104. The Web page 400 is divided into three sections, including a “new/edit expenses” section, “expense activity” section, and the search dialog box, previously discussed. The “new/edit expenses” section also includes the buttons “delete,” “reset,” and “apply.” The functionalities of these buttons are similar to ones discussed in connection with the Web page 300 of FIG. 3, and for brevity purposes, they will not be repeated here.

Two rows allow the real estate agent 102 to enter information connected with expense transactions. The first row allows the real estate agent 102 to enter the expense date, the expense amount (or the cost of the expense), the expense category, and notes. The expense date, when entered, allows the system 100 to determine the month in which to display an expense transaction. The expense category is selected from a drop-down menu containing menu items such as airfare, advertising and marketing, administration, automotive, client and payment, reproduction, dues, education, facts, fees, gas, Internet, lock box, meals, office supplies, phone, postage and shipping, posts, signs, taxi, training, other, and depreciation.

The category portion of the first row of the Web page 400 allows the real estate agent 102 to customize a particular expense category of his devising if a desired category cannot be found in the drop-down menu. The second row allows the real estate agent 102 to specify a payment type connected with the expense transaction. Payment types are contained in a drop down menu that includes cash, credit, debit, and check. The payment type portion of the second row allows the real estate agent 102 to devise his own customized payment type. A client portion of the second row allows the real estate agent 102 to couple expense transactions with a particular client.

Below the “new/edit expenses” section is the expense activity section, which preferably displays month hyperlinks from January to December. Not all of the months are shown in FIG. 4, and depending on the internet client 104, all month hyperlinks may be displayed. Preferably, a current month in which expense transactions are shown is highlighted, allowing the real estate agent 102 to have a context of the expense transactions. The expense transactions are shown in columns, including client name, expense date, amount, payment type, category, and notes. Not shown in FIG. 4 is the ability of the real estate agent 102 to select a particular year in which to view expense transactions. If the real estate agent 102 enters an expense date that is in a different month than what is being displayed by the Web page 400, the new month will be automatically switched into view so as to allow the real estate agent 102 to maintain the same month context.

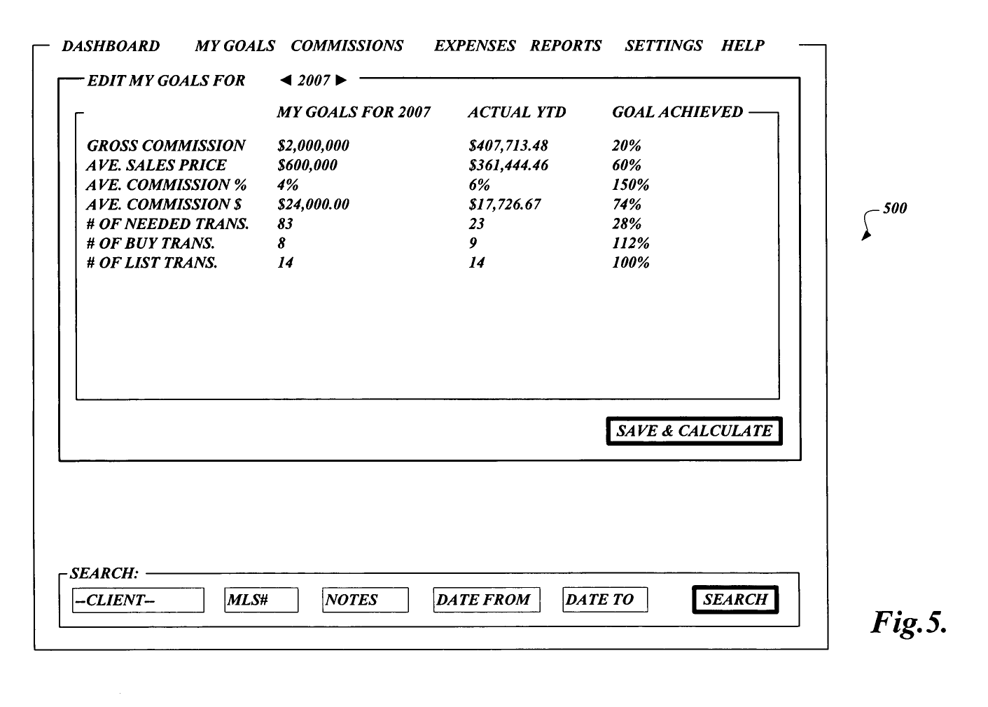

FIG. 5 illustrates a Web page 500 that includes hyperlinks at the top of the Web page similar to ones shown previously connected with Web pages 300, 400 of FIGS. 3, 4. These hyperlinks include “dashboard,” “mygoals,” “commissions,” “expenses,” “reports,” “settings,” and “help.” Upon selection of the hyperlink “my goals,” the Web page 500 appears. A button “save and calculate” is shown at the bottom of “edit my goals for” section of the Web page 500. Upon selection of the “save and calculate” button, the system 100 will save pieces of data connected with the goals set by the real estate agent 102 to the database server 112 and calculate percentages and other data to indicate how close the real estate agent 102 is to achieving his goals. A hyperlink “triangle symbol pointing to the left” [symbol] allows the real estate agent 102 to traverse back in time to previous years to see goals connected with those years. Another hyperlink “a triangle pointing to the right” [symbol] allows the real estate agent 102 to traverse forward into the future years, revealing goals connected with those years.

The currently selected year, such as “2007,” appears between the two triangle symbols. Four columns appear underneath the “edit my goals for” section. The first column includes the nomenclatures for various goals desired by the real estate agent 102, and they include gross commission, average sales price, average commission percentage, average commission dollars, number of needed transactions, number of buy transactions, and number of list transactions. The second column is titled “my goals for 2007” and the cells underneath the column include the numerical values connected to each of the goals described textually to its left. The third column is titled “actual year to date,” which discloses the results achieved so far to date. The fourth column is titled “goal achieved” and it lists percentages that give a snapshot of the performances in terms of percentage.

Regarding the values of various cells of the “my goals for 2007” column, the average commission dollar amount is the average sales price in the “my goals for 2007” column multiplied by the average commission percentage also in the “my goals for 2007” column; and the number of transactions in the “my goals for 2007” column is generated by taking the gross commission in the “my goals for 2007” column divided by the average commission amount in the “my goals for 2007” column.

Regarding the values of various cells of the “actual year to date” column, the gross commission is the total gross commissions for all commission transactions; the average sales price is the total dollars of sales amounts divided by the number of total commission transactions; the average commission percentage is the total of all commission percentages for all entries divided by the total number of commission transaction entries; the average commission amount is the average sales price multiplied by the average commission percentage, both being in the “actual year to date” column. The number of transactions for the “actual year to date” column is calculated by taking the gross commission in the “actual year to date” column divided by the average commission amount in the “actual year to date” column. The number of buy transactions for the “actual year to date” column is the total number of commission transactions categorized as “buy,” and the number of list transactions for the “actual year to date” column is the total number of commission transactions categorized as “list.”

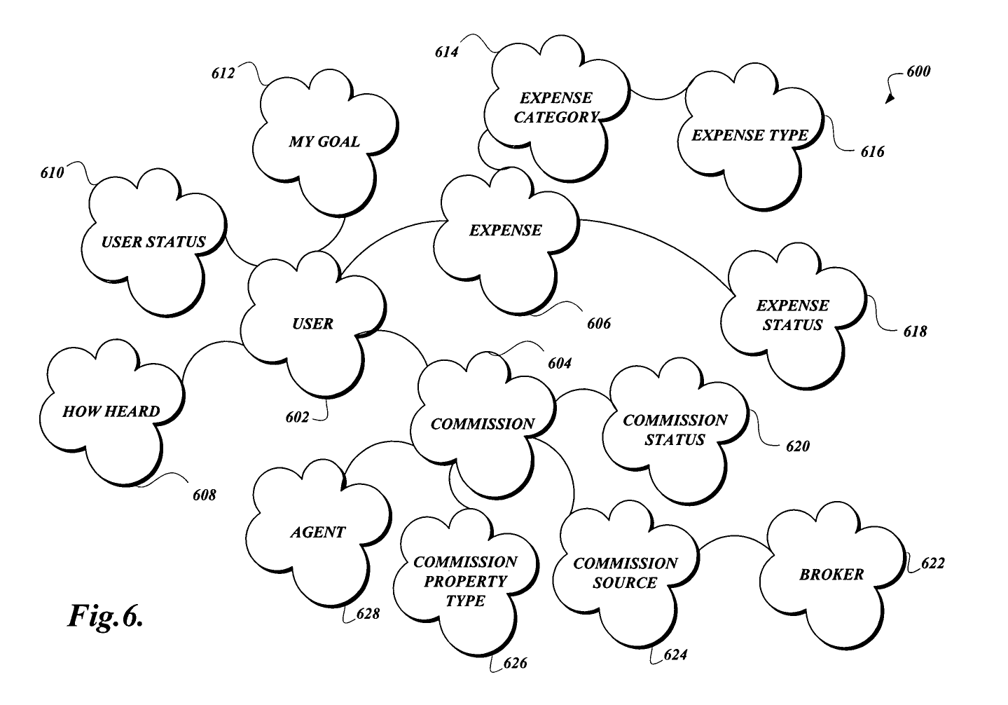

FIG. 6 illustrates a portion of a collection of database tables 602-628, collectively referenced as a schema 600. Each database table 602-628 is basically a file composed of records, each containing fields together with a set of operations for searching, sorting, recombining, and performing other database functions. Each record of database tables 602-628 has a data structure, which is characterized by rows and columns with data occupying or potentially occupying each cell formed by a row-column intersection. Information regarding users, commissions, and expenses therefor has a data structure for describing such information. Many pieces of information are stored by the database besides those mentioned hereinabove, such as goals, commissions, property type, source of commissions, broker, and so on. A portion of such data structure is illustrated by the schema 600, as shown in FIG. 6.

The schema 600 includes: a user table 602; an expense table 606; an expense category table 614; an expense type table 616; an expense status table 618; a commission table 604; a commission status table 620; a commission source table 624; a broker table 622; a commission property type table 626; an agent table 628; a how heard table 608; a user status table 610; and a mygoal table 612. Each table 602-628 has a number of fields. Information regarding the commission transactions and expense transactions is stored in these fields, which form the columns of a table with information occupying the rows. These tables 602-628 facilitate searches by using data in specified columns in one table to find additional data in another table. Information is matched from a field in one table with information in a corresponding field of another table to produce results for queries that combine requested data from both tables. For example, user table 602 contains a userID field and the commission table 604 contains a number of fields, including a userID field. The database server 112 can match the userID fields in the two tables 602, 604 to find information (all commission transactions connected with a particular user). In other words, a database uses matching values in two tables to relay information in one to information in the other.

The user table 602 contains the previously discussed userID field; sessionID field; userStatusID field; firstname field; lastname field; title; mobilephone field; homephone field; homeaddress1 field; homeaddress2 field; homecity field; homestateID field; homezip field; officephone field; officeaddress1 field; officeaddress2 field; officecity field; officestateID field; officezip field; emailaddress field; password field; registrationdate field; terminationdate field; passwordattempts field; passwordlastattempt field; passwordlock field; agreedtoTOA field; howheardID field; incometaxrate field; paymentplanID field; brokerID field; mysplitpercentage field; brokersplitfieldpercentage field; mydailyquestions field; logkey field; and lastlogindate field.

The how heard table 608 includes a howheardID field and a howheardname field. The user status table 610 includes a userStatusID field and a userstatusname field. The expense table 606 includes an expenseID field, a userID field, a commissionID field, an expensecategoryID field, an expensetypeID field, an expensestatusID field, amount field; entrydate field, expensedate field, and notes field.

The expense category table 614 includes an expensecategoryID field, an expensecategoryname field, and a userID field. The expense type table 616 includes an expensetypeID field, an expensetypename field, and a userID field. The expense status table 618 includes an expensestatusID field and an expensestatusname field.

The commission table 604 includes: a commissionID field; a userID field; an MLSnum field; a salesprice field; a commissionpercentage field; a mysplitpercentage field; a brokersplitpercentage field; an agent2percentage field, which describes the portion that a second real estate agent earns from the commissions of the primary real estate agent; an incometaxratepercentage field; a flatratecommission field; a closingdate field; a paydate field; an entrydate field; a propertytypeID field; a sourceID field; a listbyagentID field; a notes field; a clientname field; a commissionstatusID field; a grosscommission field; an aftersplit field; a tax field; and a netcommission field.

The commission status table 620 includes a commissionstatusID field and a commissionstatusname field. The commission source table 624 includes a sourceID field, a sourcename field, and a userID field. The broker table 622 includes a brokerID field, a brokername field, a userID field, and a brokerURL field. A commission property type table 626 includes a propertytypeID field, a propertytypename field, and a userID field. The agent table 628 includes a listbyagentID field and a listbyagentname field.

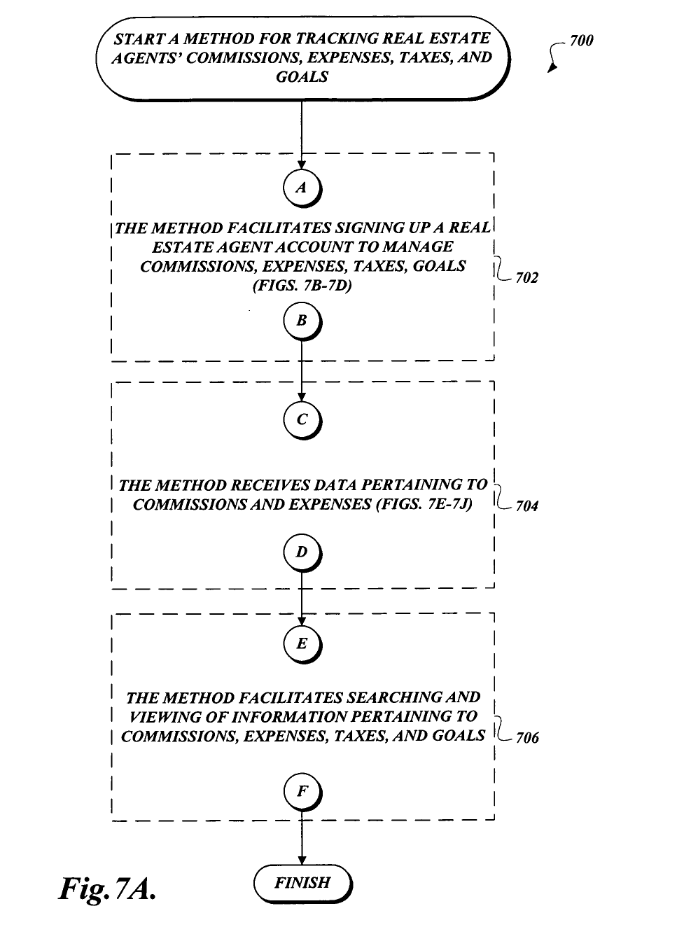

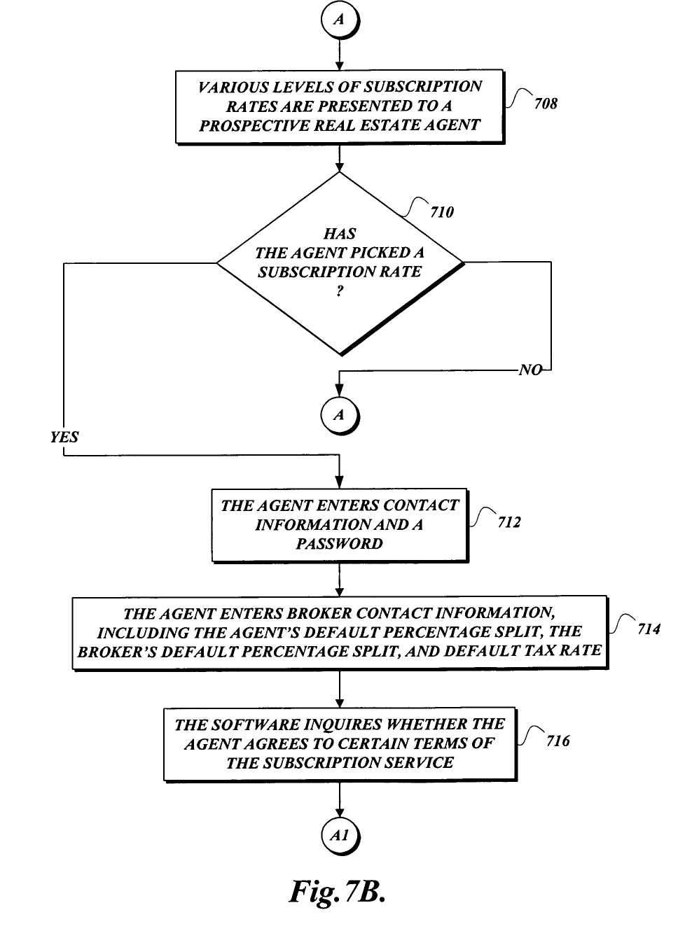

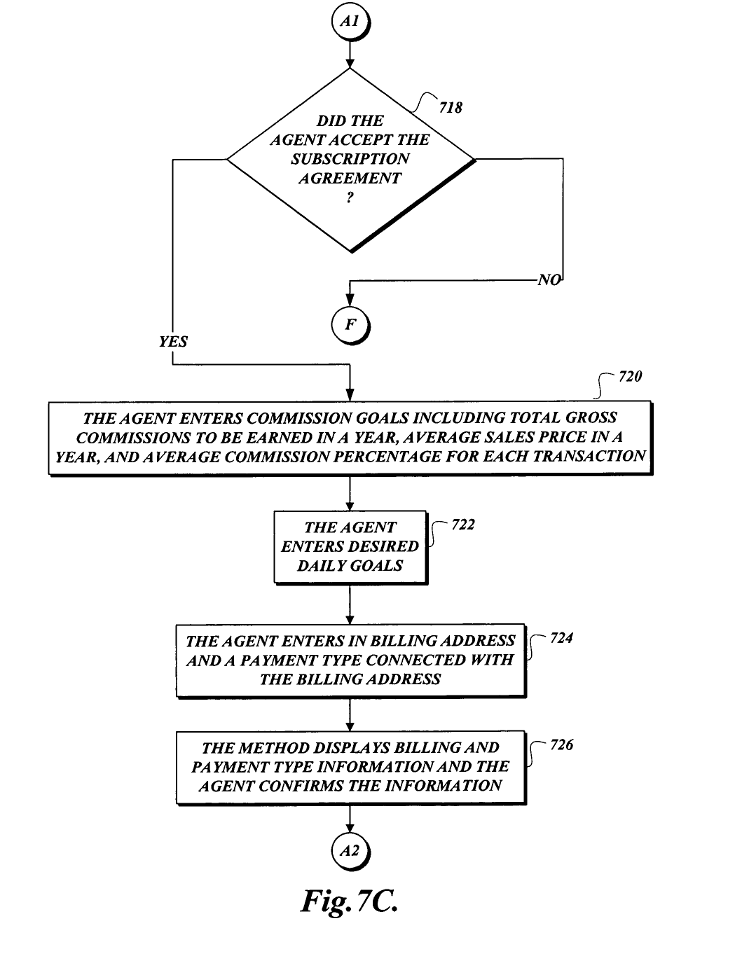

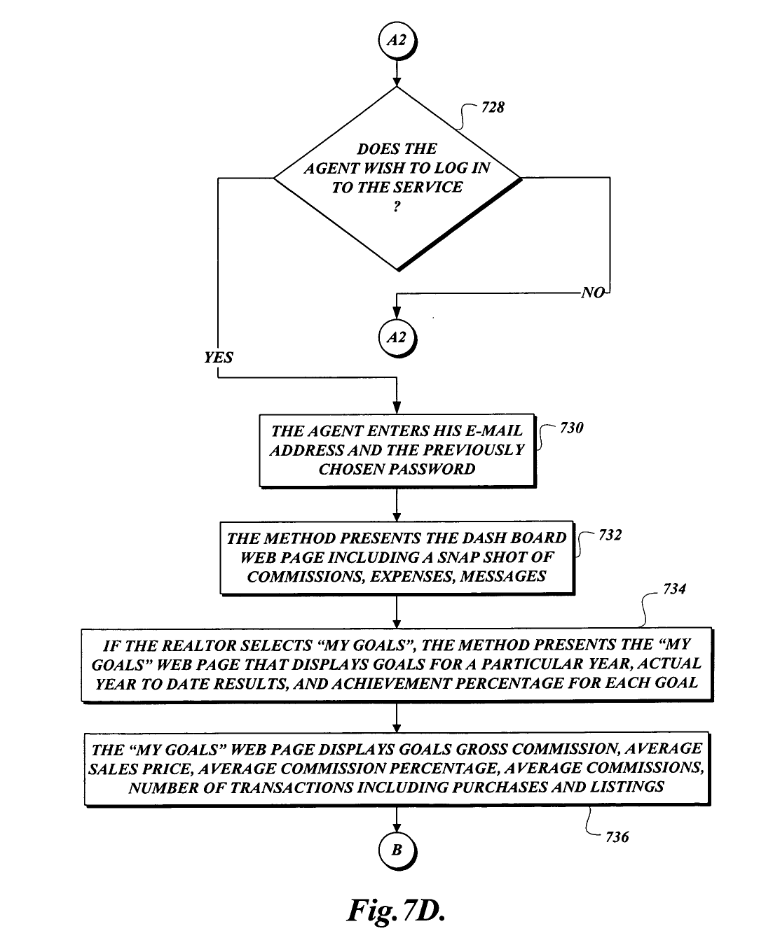

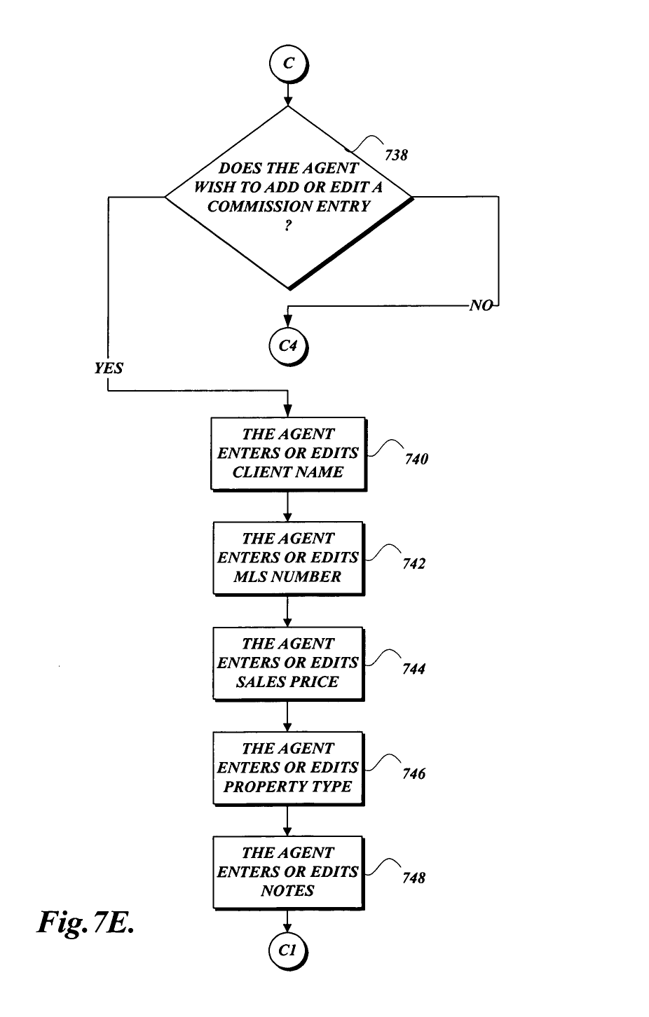

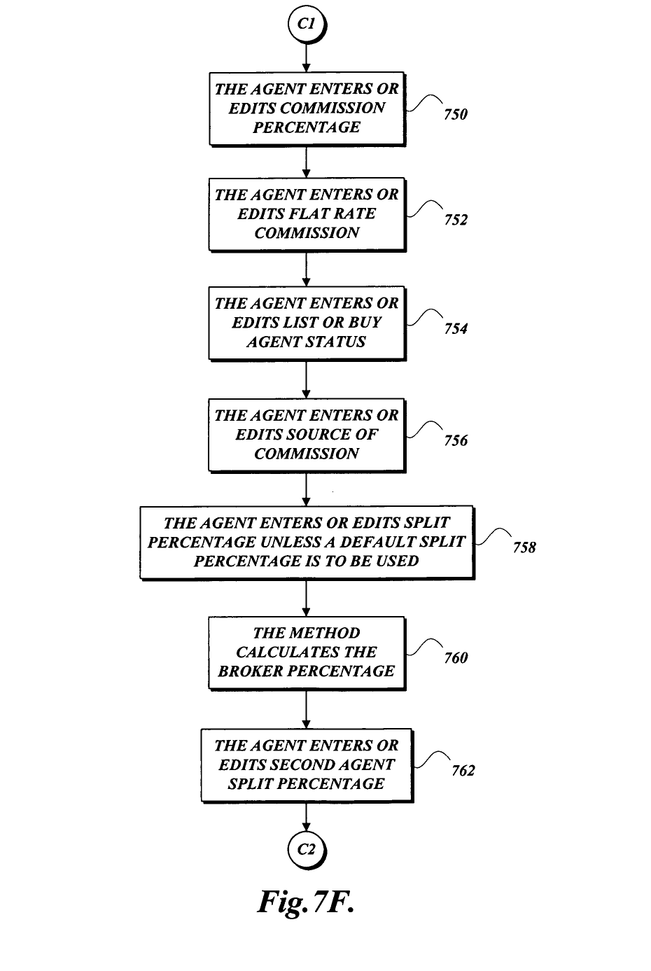

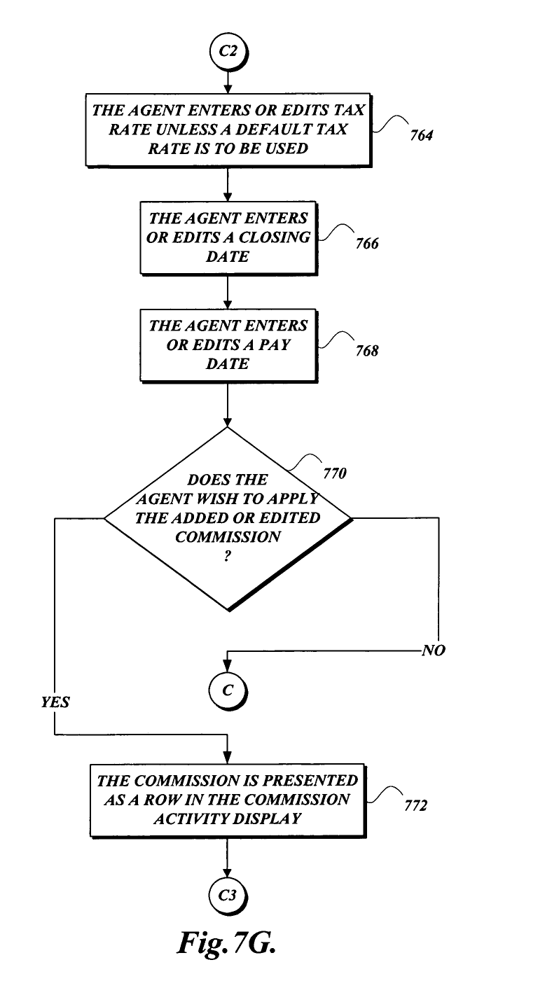

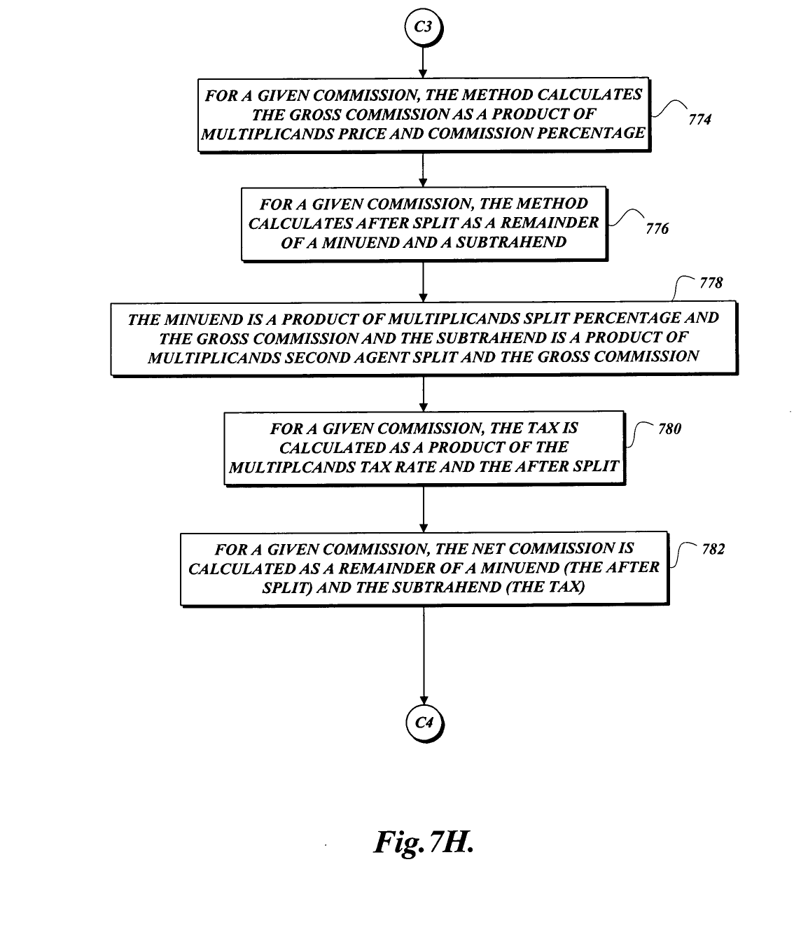

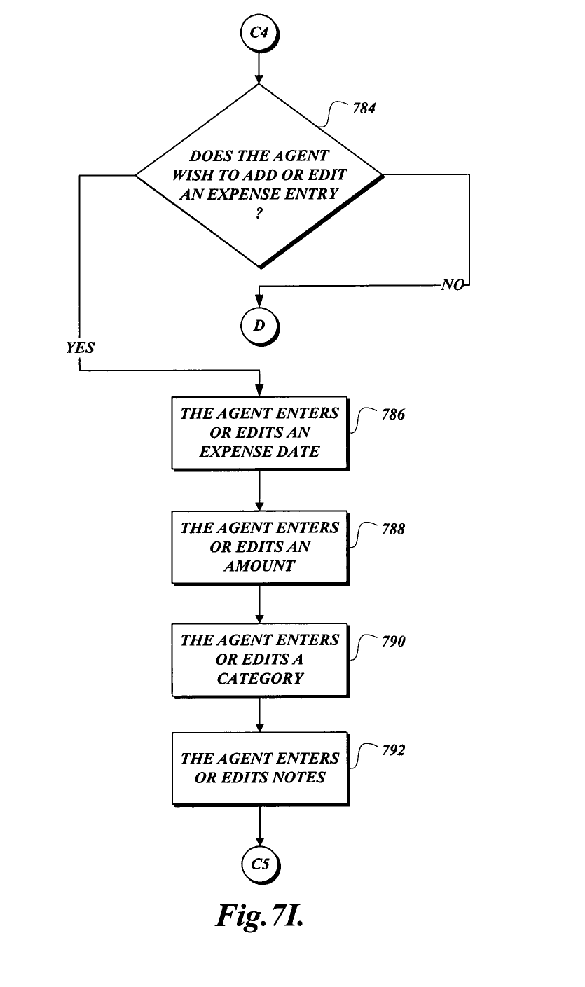

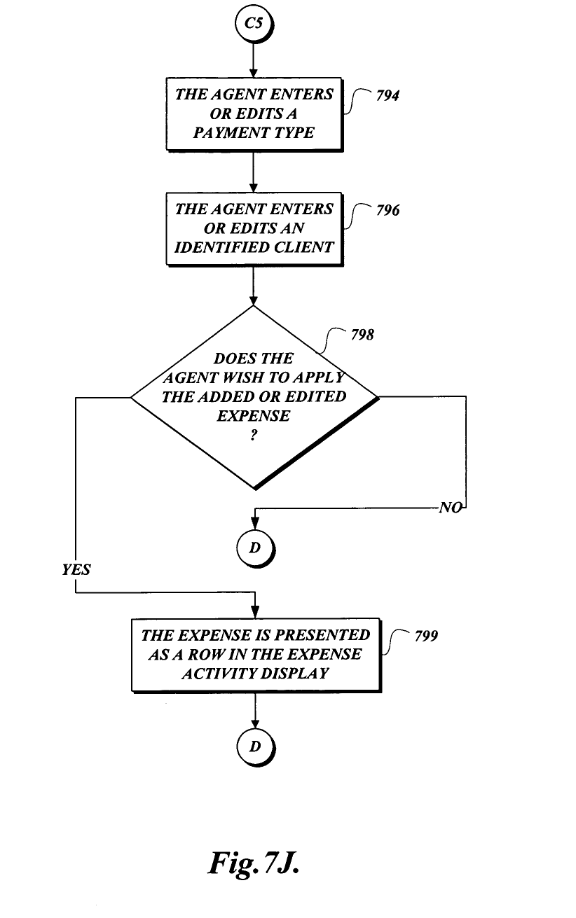

FIGS. 7A-7J illustrate a method 700 for tracking real estate agents' commissions, expenses, taxes, and goals. From a start block, the method 700 proceeds to a set of method steps 702, defined between a continuation terminal (“terminal A”) and an exit terminal (“terminal B”). The set of method steps 702 describes that the method facilitates signing up a real estate agent account to manage commissions, expenses, taxes, goals, and so on. From terminal A (FIG. 7B), the method 700 proceeds to block 708 where various levels of subscription rates are presented to a prospective real estate agent. At decision block 710, a test is performed to determine whether the real estate agent has picked a subscription rate. If the answer to the test at decision block 710 is NO, the method continues to terminal A and skips to block 708, where the above-described processing steps are repeated. Otherwise, if the answer to the test at decision block 710 is YES, then method proceeds to block 712, where the real estate agent enters contact information and a password. The real estate agent enters broker contact information including the real estate agent's default percentage split, the broker's default percentage split, and default tax rate at block 714. At block 716, the software inquires whether the real estate agent agrees to certain terms of the subscription service. The method 700 then continues to another continuation terminal (“terminal A1”).

From terminal A1 (FIG. 7C), the method 700 proceeds to decision block 718 where a test is performed to determine whether the real estate agent accepts the subscription agreement. If the answer to the test at decision block 718 is NO, the method 700 proceeds to another continuation terminal (“terminal F”) where it terminates its execution. Otherwise, if the answer to the test at decision block 718 is YES, then the method 700 proceeds to block 720 where the real estate agent enters commission goals, including total gross commissions to be earned in a year, average sales price in a year, and average commission percentage for each transaction. At block 722, the real estate agent enters desired daily goals. At block 724, the real estate agent enters a billing address and payment type connected with the billing address. At block 726, the method displays billing and payment type information and the real estate agent confirms the information. The method 700 then proceeds to another continuation terminal (“terminal A2”).

From terminal A2 (FIG. 7D), a test is performed at decision block 728 to determine whether the real estate agent wishes to log into the subscription service. If the answer is NO to the test at decision block 728, the method continues to terminal A2 to loop back and repeat the previously discussed processing steps. Otherwise, if the answer to the test at decision block 728 is YES, then the method 700 proceeds to block 730, where the real estate agent enters his or her e-mail address and the previously chosen password. At block 732, the method 700 presents the dashboard Web page, including a snapshot of commissions, expenses, and messages. If the real estate agent selects “my goals,” the method presents the “my goals” Web page that displays goals for a particular year, actual year to date results, and achievement percentage for each goal. See block 734. At block 736, the “my goals” Web page displays goals, gross commission, average sales price, average commission percentage, average commissions, and number of transactions including purchases and listings. The method 700 then proceeds to terminal B. From terminal B (FIG. 7A), the method 700 proceeds to a set of method steps 704 defined between a continuation terminal (“terminal C”) and an exit terminal (“terminal D”). The set of method steps 704 describes that the method receives data pertaining to commissions and expenses.

From terminal C (FIG. 7E), the method 700 proceeds to decision block 738, where a test is performed to determine whether the real estate agent wishes to add or edit a commission entry. If the answer to the test at decision block 738 is NO, the method continues to another continuation terminal (“terminal C4”). If the answer to the test at decision block 738 is YES, the method continues to block 740 where the real estate agent enters or edits client name. At block 742, the real estate agent enters or edits an MLS number. At block 744, the real estate agent enters or edits sales price. At block 746, the real estate agent enters or edits property type. At block 748, the real estate agent enters or edits notes. The method then continues to another continuation terminal (“terminal C1”).

From terminal C1 (FIG. 7F), the real estate agent enters or edits a commission percentage at block 750. At block 752, the real estate agent enters or edits the flat rate commission if the commission percentage has not already been selected. At block 754, the real estate agent enters or edits whether he or she is a listing or a buying agent. At block 756, the real estate agent enters or edits the source of commission. The real estate agent enters or edits split percentage unless a default split percentage is to be used at block 758. At block 760, the method calculates the broker percentage. Both the split percentage and the broker percentage sum to 100%. The real estate agent may enter or edit a second agent split percentage at block 762 if another agent will earn a portion of the commission earned by the primary real estate agent. The method 700 then proceeds to another continuation terminal (“terminal C2”).

From terminal C2 (FIG. 7G), the real estate agent enters or edits tax rate unless a default tax rate is to be used at block 764. At block 766, the real estate agent enters or edits a closing date. At block 768, the real estate agent enters or edits a pay date. At decision block 770, a test is performed to determine whether the real estate agent wishes to use the created or edited commission transaction. If the answer to the test at decision block 770 is NO, the method continues to terminal C and skips back where the above-identified processing steps are repeated. Otherwise, if the answer to the test at decision block 700 is YES, then the method proceeds to block 772 where the commission is presented as a row in the commission activity display. The method then continues to another continuation terminal (“terminal C3”).

From terminal C3 (FIG. 7H), the method 700 proceeds to block 774 where, for a given commission, the method calculates the gross commission as a product of multiplicands price and commission percentage. At block 776, for a given commission, the method calculates after split as a remainder of a minuend and a subtrahend. The minuend is a product of multiplicands split percentage and a gross commission, and the subtrahend is a product of multiplicands second agent split and the gross commission. See block 778. At block 780, for a given commission, the tax is calculated as a product of the multiplicands tax rate and the after split. At block 782, for a given commission, the net commission is calculated as a remainder of a minuend (the after split) and the subtrahend (the tax). The method 700 then continues to terminal C4.

From terminal C4 (FIG. 71), a test is performed at decision block 784 to determine whether the real estate agent wishes to add or edit an expense entry. If the answer to the test at decision block 784 is NO, the method 700 proceeds to the exit terminal D. Otherwise, if the answer to the test at decision block 784 is YES, then the method 700 proceeds to block 786 where the real estate agent enters or edits an expense date. At block 788, the real estate agent enters or edits an amount. At block 790, the real estate agent enters or edits a category. At block 792, the real estate agent enters or edits notes. The method then continues to another continuation terminal (“terminal C5”).

From terminal C5 (FIG. 7J), the method 700 proceeds to block 794 where the real estate agent enters or edits a payment type. At block 796, the real estate agent enters or edits an identified client. A test is performed at decision block 798 to determine whether the real estate agent wishes to apply the added or edited expense. If the answer is NO to the test at decision block 798, the method 700 proceeds to the exit terminal D. Otherwise, if the answer to the test at decision block 798 is YES, then the method 700 continues to block 799 where the expense is presented as a row in the expense activity display. The method then continues to exit terminal D.

From terminal D (FIG. 7A), the method 700 proceeds to a block of method steps 706 defined between a continuation terminal (“terminal E”) and an exit terminal F. The set of method steps 706 facilitates the searching and viewing of information pertaining to commissions, expenses, taxes, and goals. While illustrative embodiments have been illustrated and described, it will be appreciated that various changes can be made therein without departing from the spirit and scope of the invention.

The embodiments of the invention in which an exclusive property or privilege is claimed are defined as follows:

1. A method for tracking real estate transactions over a network, comprising:
presenting a first Web page that creates a tracking service for a real estate agent and receiving over the network a selection for one of many tracking subscription service levels, a split percentage for the real estate agent, a split percentage for a broker, and a tax rate; and
presenting a second Web page that creates a transaction to be tracked by the tracking service and receiving over the network a client name connected with the transaction, a multiple listing service number, a sales price for a piece of property, a property type, a commission rate, a source of the commission, a split percentage, and a closing date.

2. The method of claim 1, wherein presenting the second Web page includes displaying created transactions in columns, which columns include gross commission, price, commission percentage, split percentage, second agent split, after split amount, tax rate, tax, and net commission.

3. The method of claim 2, wherein values in the gross commission column are calculated by taking a product of price as a first multiplicand and commission percentage as a second multiplicand.

4. The method of claim 3, wherein values in the after split amount column are calculated by taking a remainder of a minuend and a subtrahend, the minuend being a product of split percentage as a third multiplicand and gross commission as a fourth multiplicand, the subtrahend being a product of second agent split as a fifth multiplicand and gross commission as a sixth multiplicand.

5. The method of claim 4, wherein values in the tax column are calculated as a product of tax rate as a seventh multiplicand and after split amount as an eighth multiplicand.

6. The method of claim 5, wherein values in the net commission column are calculated by taking a remainder of the after split amount as a minuend and the tax as the subtrahend.

7. A computer system for tracking real estate transactions over a network, comprising:
a server that executes software for sending a first Web page to an Internet client to create a tracking service for a real estate agent, the server receiving over the network a selection for one of many tracking subscription service levels, a split percentage for the real estate agent, a split percentage for a broker, and a tax rate, the server sending a second Web page to create a transaction to be tracked by the tracking service and receiving over the network a client name connected with the transaction, a multiple listing service number, a sales price for a piece of property, a property type, a commission rate, a source of the commission, a split percentage, and a closing date; and
a database server for storing the selection for one of many tracking subscription service levels, the split percentage for the real estate agent, the split percentage for a broker, and the tax rate, the transaction to be tracked by the tracking service, including the client name connected with the transaction, the multiple listing service number, the sales price for the piece of property, the property type, the commission rate, the source of the commission, the split percentage, and the closing date.

8. The computer system of claim 7, wherein the software that presents the second Web page also displays created transactions in columns, which columns include gross commission, price, commission percentage, split percentage, second agent split, after split amount, tax rate, tax, and net commission.

9. The computer system of claim 7, further comprising another piece of software for calculating values in the gross commission column by taking a product of price as a first multiplicand and commission percentage as a second multiplicand.

10. The computer system of claim 9, further comprising an additional piece of software for calculating values in the after split amount column by taking a remainder of a minuend and a subtrahend, the minuend being a product of split percentage as a third multiplicand and gross commission as a fourth multiplicand, the subtrahend being a product of second agent split as a fifth multiplicand and gross commission as a sixth multiplicand.

11. The computer system of claim 4, further comprising a further piece of software for calculating values in the tax column by taking a product of tax rate as a seventh multiplicand and after split amount as an eighth multiplicand.

12. The computer system of claim 5, further comprising an added piece of software for calculating values in the net commission column by taking a remainder of the after split amount as a minuend and the tax as the subtrahend.

13. A computer-readable medium having computer-executable instructions stored thereon for implementing a method for tracking real estate transactions over a network, comprising:
presenting a first Web page that creates a tracking service for a real estate agent and receiving over the network a selection for one of many tracking subscription service levels, a split percentage for the real estate agent, a split percentage for a broker, and a tax rate; and
presenting a second Web page that creates a transaction to be tracked by the tracking service and receiving over the network a client name connected with the transaction, a multiple listing service number, a sales price for a piece of property, a property type, a commission rate, a source of the commission, a split percentage, and a closing date.

14. The computer-readable medium of claim 13, wherein presenting the second Web page includes displaying created transactions in columns, which columns include gross commission, price, commission percentage, split percentage, second agent split, after split amount, tax rate, tax, and net commission.

15. The computer-readable medium of claim 14, wherein values in the gross commission column are calculated by taking a product of price as a first multiplicand and commission percentage as a second multiplicand.

16. The computer-readable medium of claim 15, wherein values in the after split amount column are calculated by taking a remainder of a minuend and a subtrahend, the minuend being a product of split percentage as a third multiplicand and gross commission as a fourth multiplicand, the subtrahend being a product of second agent split as a fifth multiplicand and gross commission as a sixth multiplicand.

17. The computer-readable medium of claim 16, wherein values in the tax column are calculated as a product of tax rate as a seventh multiplicand and after split amount as an eighth multiplicand.

18. The computer-readable medium of claim 17, wherein values in the net commission column are calculated by taking a remainder of the after split amount as a minuend and the tax as the subtrahend.
